(19) United States
(12) Patent Application Publication
(10) Pub. No.: US 2013/0155210 A1
(43) Pub. Date: Jun. 20, 2013

(54) Shutter Glasses, Three-Dimensional Video System and Shutter Glasses Control Method

(71) Applicant: Yuan-Lang Ma, Hsinchu City (TW)

(72) Inventor: Yuan-Lang Ma, Hsinchu City (TW)

(21) Appl. No.: 13/412,576

(22) Filed: Mar. 5, 2012

(30) Foreign Application Priority Data
Dec. 20, 2011 (TW) 100147441

(51) Int. Cl. H04N 13/04

(52) U.S. Cl. 348/56; 348/E13.026

(57) ABSTRACT

Shutter glasses for a three-dimensional video system includes a first lens, a second lens, a lens control module coupled to the first lens and the second lens for alternately blocking the first lens and the second lens according to a synchronization signal, an image capturing device for capturing a plurality of images including a synchronization image outputted from a display of the three-dimensional video system, and a timing generating module coupled to the image capturing device for generating the synchronization signal according to the synchronization image.

### BACKGROUND OF THE INVENTION

1. Field of the Invention

The present invention relates to shutter glasses, a three-dimensional video system and shutter glasses control method, and more particularly, to shutter glasses, a three-dimensional video system and shutter glasses control method capable of achieving synchronization via capturing an image generated from a display.

2. Description of the Prior Art

With the development of multimedia technology, consumers are pursing stereoscopic and more realistic three-dimensional images rather than high quality images. The primary underlying principle for three-dimensional image display is to present two different images with an offset in visual angle separately to the left and the right eye of the viewer, so as to create the illusion of depth of field and gradation when the viewer's brain superimposes the two offset images and perceives a three-dimensional image. There are two techniques for present three-dimensional image display. One is to use a display which collaborates with three-dimensional viewing glasses, such as shutter glasses or polarization glasses, while the other is to directly use the display without any accompanying three-dimensional viewing glasses, such as parallax barrier. The polarization glasses and the parallax barrier both require a panel specially manufactured, and thereby, the shutter glasses have been a main three-dimensional image display technology.

The working axiom of the shutter glasses is to open and shut the left and right LCD lens of the glasses alternately according to a synchronization control signal transmitted from the display. That is, when the right-eye LCD lens is open and the left-eye LCD lens shut, a screen synchronously displays an image for the right eye; similarly, when the left-eye LCD lens is open and the right-eye LCD lens shut, the screen synchronously displays an image for the left eye, and then the three-dimensional image is matched by vision persistence in the viewer's brain. Since the shutter glasses open and shut the left and right LCD lens of the glasses separately according to the synchronization control signal transmitted from the display, the display needs to collaborate with exclusive shutter glasses. In other words, consumers need to purchase as a set shutter glasses designed for a specific three-dimensional video system to view the three-dimensional images and cannot only purchase shutter glasses to collaborate with the original display. In such a condition, the willingness of the consumers to buy may be reduced, and resources are not utilized efficiently.

### SUMMARY OF THE INVENTION

It is therefore an objective of the present invention to provide shutter glasses, three-dimensional video system and shutter glasses control method capable of achieving synchronization without adding a device to transmit a synchronization control signal in a display.

The present invention discloses shutter glasses for a three-dimensional video system. The shutter glasses includes a first lens, a second lens, a lens control module, coupled to the first lens and the second lens, for alternately blocking the first lens and the second lens according to a synchronization signal, an image capturing device, for capturing a plurality of images including a synchronization image outputted from a display of the three-dimensional video system, and a timing generating module, coupled to the image capturing device, for generating the synchronization signal according to the synchronization image.

The present invention further discloses a three-dimensional video system for displaying three-dimensional images. The three-dimensional video system includes a display, an image display control unit, and shutter glasses. The image display control unit, coupled to the display, for controlling the display to generate a plurality of images including a synchronization image. The shutter glasses includes a first lens, a second lens, a lens control module, coupled to the first lens and the second lens, for alternately blocking the first lens and the second lens according to a synchronization signal, an image capturing device, for capturing a plurality of images including a synchronization image outputted from a display of the three-dimensional video system, and a timing generating module, coupled to the image capturing device, for generating the synchronization signal according to the synchronization image.

The present invention further discloses a shutter glasses control method for a three-dimensional video system. The shutter glasses control method includes steps of outputting a plurality of images including a synchronization image from a display of the three-dimensional video system; generating a synchronization signal according to the synchronization image; and alternately blocking a first lens and a second lens of shutter glasses according to the synchronization signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a three-dimensional video system according to an embodiment of the present invention.

FIG. 2A is a schematic diagram of a timing generating module shown in FIG. 1 according to an embodiment of the present invention.

FIG. 2B is a schematic diagram of related signals of the timing generating module shown in FIG. 2A according to an embodiment of the present invention.

FIG. 3 is a flowchart of a shutter glasses control process according to an embodiment of the present invention.

### DETAILED DESCRIPTION

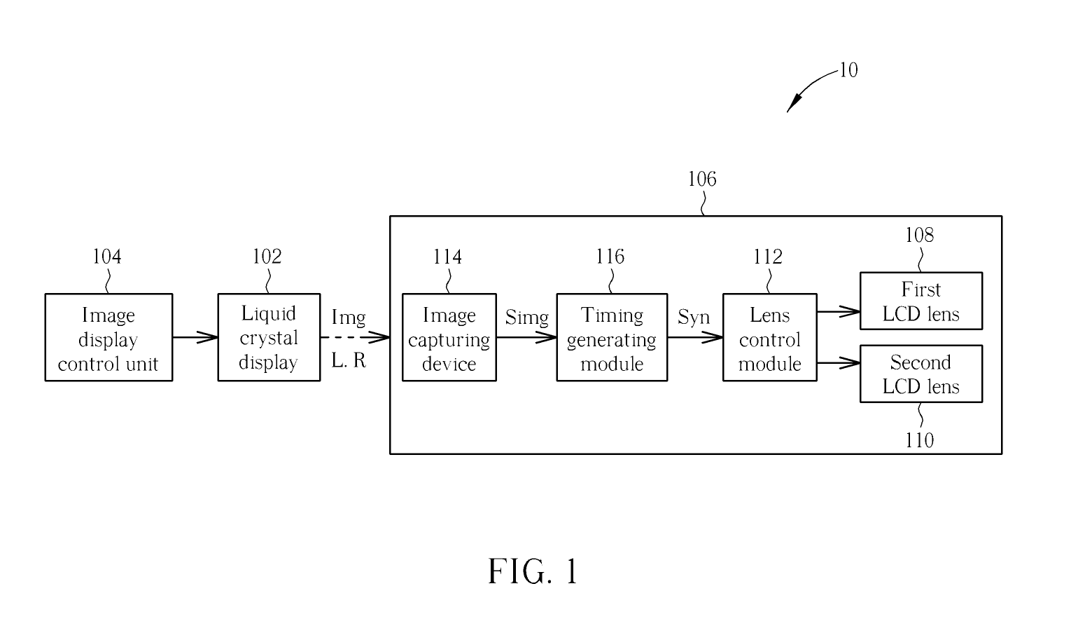

Please refer to FIG. 1, which is a schematic diagram of a three-dimensional video system 10 according to an embodiment of the present invention. The three-dimensional image system 10 is utilized for generating a three-dimensional image. The three-dimensional image system 10 includes an LCD display 102, an image display control unit 104 and shutter glasses 106. The image display control unit 104 can control the LCD display 102 to generate not only a general image (such as a left-eye image L and a right-eye image R) but also a synchronization image Img or output a synchronization image data to the LCD display 102, for the shutter glasses 106 to perform synchronization. In other words, the LCD display 102 and the shutter glasses 106 can have a non-exclusive relationship, i.e. the LCD display 102 and the shutter glasses 106 can be designed and manufactured separately, and thereby, users can view the three-dimensional images by purchasing the shutter glasses 106 and the image display control unit 104 which collaborate with the original display.

In detail, the shutter glasses 106 include a first LCD lens 108, a second LCD lens 110, a lens control module 112, an image capturing device 114 and a timing generating module 116. The first LCD lens 108 and the second LCD lens 110 separately correspond to the user's left eye and right eye. When viewing the three-dimensional images, the image capturing device 114 captures the synchronization image Img and converts the synchronization image Img into a synchronization image signal Syn to output to the timing generating module 116, and then the timing generating module 116 can generate a synchronization signal Syn to the lens control module 112 accordingly. The lens control module 112 can alternately block the first LCD lens 108 and the second LCD lens 110 according to the synchronization signal Syn, so as to view the three-dimensional images. In short, the shutter glasses 106 can achieve synchronization with the LCD display 102 via capturing the synchronization image Img generated from the LCD display 102.

Note that, FIG. 1 is utilized for illustrating the concept of the present invention, and those skilled in the art may make alterations or modifications accordingly, and is not limited to this. For example, the image display control unit 104 may be any kind of multimedia generating devices, such as a digital media playing system, a set-top box or a network video player etc. The image display control unit 104 may be disposed either outside the LCD display 102 or inside the LCD display 102, depending on system requirements. The image capturing device 114 may be any form of image detecting elements, such as a charge-coupled device (CCD), a complementary metal-oxide-semiconductor (CMOS) etc., or special design, such as coating, etching etc., to facilitate capture the synchronization image Img.

Besides, in FIG. 1, a type and a format of the synchronization image Img are also not limited. The synchronization image Img may be positioned in front of all images or inserted in images, to achieve synchronization with the shutter glasses 106, and the format may comprise not only cross images with blue and red but also other forms, e.g. frame images with black and white etc., as long as facilitating recognition, and is not limited to this. The derivative applications are known to those skilled in the art.

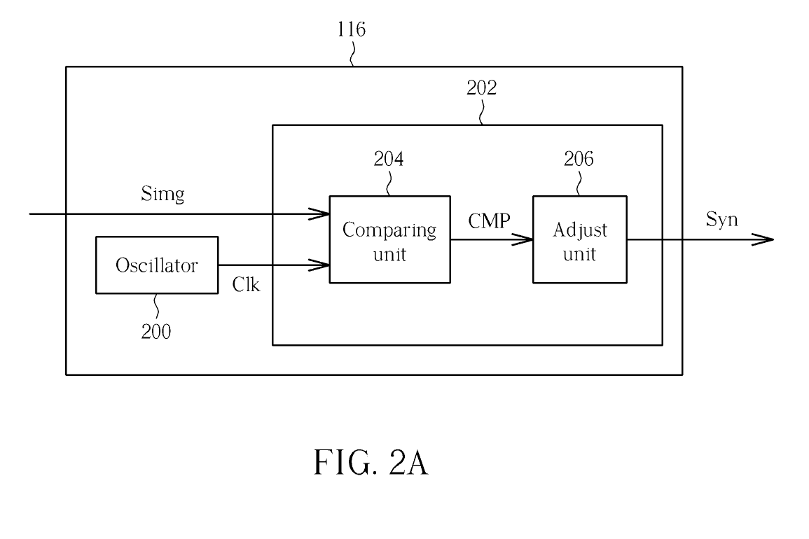

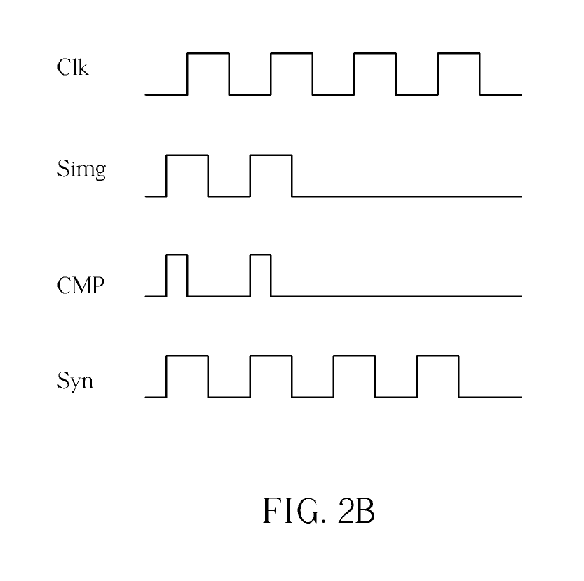

On the other hand, the timing generating module 116 shown in FIG. 1 is mainly utilized for generating the synchronization signal Syn. Note that, the method for generating synchronization signal Syn by the timing generating module 116 is not restricted in any rule or regulation. For example, please refer to FIG. 2A, which is a schematic diagram of the timing generating module 116 according to an embodiment of the present invention. As shown in FIG. 2A, the timing generating module 116 includes an oscillator 200 and a calibrating unit 202. The oscillator 200 may be a voltage controlled oscillator (VCO), for generating a clock signal Clk which has the same frequency and a different phase as the synchronization image signal Syn. The calibrating unit 202, coupled to the oscillator 200, for adjusting the clock signal Clk to generate the synchronization signal Syn. The calibrating unit 202 includes a comparing unit 204 and an adjusting unit 206. The comparing unit 204 is utilized for comparing a phase difference of the synchronization image signal Syn and the clock signal Clk (such as comparing the phase difference of the clock signal Clk and the synchronization image signal Syn via an AND gate after the clock signal Clk has been operated on by a NOT gate), so as to generate a comparison result CMP. The adjust unit 206, coupled to the comparing unit 204, for adjusting the clock signal CLK according to the comparison result CMP, making the phase of the clock signal CLK be identical to the synchronization image Syn, to generate the synchronization signal Syn.

Please refer to FIG. 2B, which is a schematic diagram of related signals of the calibrating unit 202 shown in FIG. 2A according to an embodiment of the present invention. As can be seen from FIG. 2A and FIG. 2B, when the calibrating unit 202 receives the clock signal Clk and the synchronization image signal Syn outputted from the image capturing device 114, the comparing unit 204 compares the synchronization image signal Syn with the clock signal Clk, and the adjust unit 206 adjusts the clock signal Clk, to generate synchronization signal Syn.

FIG. 2A illustrates a feasible method of the timing generating module 116. The method adjusts the clock signal Clk via comparing the synchronization image signal Syn with the clock signal Clk, to generate the synchronization signal Syn. However, the method is not limited to this, and can also generate the synchronization signal Syn by adjusting the oscillator 200, i.e. the timing generating module 116 can also adjust an oscillating signal generated from an oscillator according to the synchronization image signal Syn, so as to output the synchronization signal Syn.

On the other hand, FIG. 2A is an embodiment having a same frequency and different phases in the clock signal Clk and the synchronization image signal Syn, and thus only adjusting the phase of the clock signal CLK be identical to the synchronization image Syn. In practice, in some embodiments, the frequency of the clock signal Clk may not be identical to the synchronization image signal Syn, requiring an adjustment of the frequency of the clock signal CLK. The derivative applications are known to those skilled in the art, and are not narrated hereinafter.

To sum up, the shutter glasses 106 can capture the synchronization image Img outputted from the LCD display 102 via the image capturing device 114, so as to make the timing generating module 116 generate the synchronization signal Syn according to the synchronization image Img. Therefore, when viewers intend to view the three-dimensional images, the shutter glasses 106 achieves synchronization with the LCD display 102 without adding a device for transmitting the synchronization control signal in the LCD display 102.

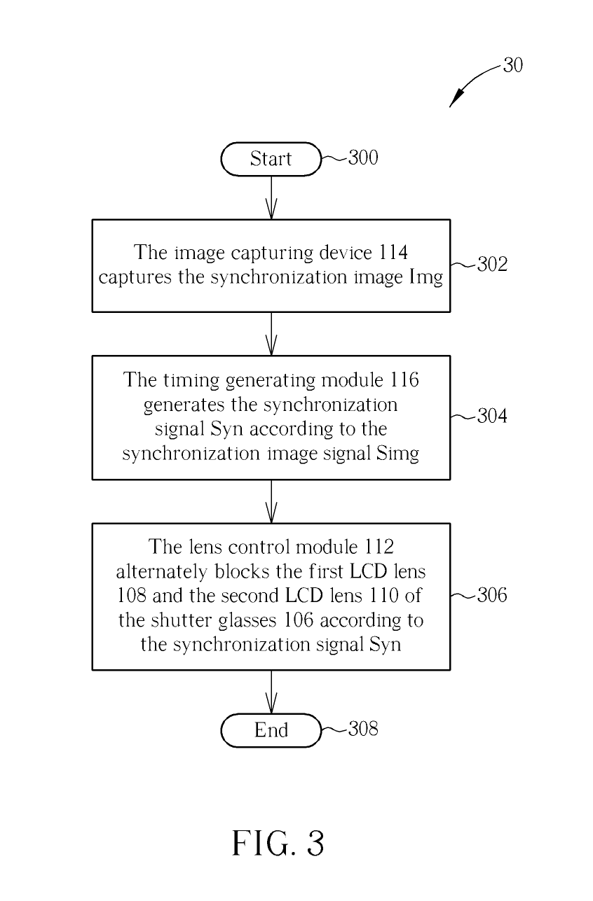

Operations of the shutter glasses 106 can be described by a shutter glasses control process 30, as shown in FIG. 3. The shutter glasses control process 30 includes the following steps:

Step 300: Start.

Step 302: The image capturing device 114 captures the synchronization image Img.

Step 304: The timing generating module 116 generates the synchronization signal Syn according to the synchronization image signal Syn.

Step 306: The lens control module 112 alternately blocks the first LCD lens 108 and the second LCD lens 110 of the shutter glasses 106 according to the synchronization signal Syn.

Step 308: End.

The detailed operations and alterations of the shutter glasses control process 30 can be derived by referring to the above, and are not narrated hereinafter.

In the prior art, the method for the shutter glasses to achieve synchronization with the display is via the synchronization control signal outputted from the display, meaning the display needs to collaborate with exclusive shutter glasses, such that consumers have to purchase as a set shutter glasses designed for a specific three-dimensional video system to view the three-dimensional images, and thus the willingness to buy of the consumers may be reduced. In comparison, the present invention achieves synchronization via capturing the synchronization image generated from the display by the shutter glasses without adding the device for transmitting the synchronization control signal in the display. In such a condition, consumers can view the three-dimensional images via the general display by purchasing the shutter glasses and the display control unit without purchasing the three-dimensional image system set.

In summary, the present invention can adapt to general display, and the shutter glasses may achieve synchronization with the display via capturing the synchronization image generated from the display by the shutter glasses.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A shutter glasses for a three-dimensional video system, comprising:
a first lens;
a second lens;
a lens control module, coupled to the first lens and the second lens, for alternately blocking the first lens and the second lens according to a synchronization signal;
an image capturing device, for capturing a plurality of images including a synchronization image outputted from a display of the three-dimensional video system; and
a timing generating module, coupled to the image capturing device, for generating the synchronization signal according to the synchronization image.

2. The shutter glasses of claim 1, wherein the timing generating module comprises:
an oscillator, for generating a clock signal; and
a calibrating unit, coupled to the image capturing device and the oscillator, for adjusting the clock signal according to the synchronization image, making frequency and phase of the clock signal be identical to the synchronization image, to generate the synchronization signal.

3. The shutter glasses of claim 2, wherein the calibrating unit comprises:
a comparing unit, for comparing frequency and phase of the clock signal and the synchronization image, to generate a comparison result; and
an adjusting unit, for adjusting the clock signal according to the comparison result, making frequency and phase of the clock signal be identical to the synchronization image, to generate the synchronization signal.

4. The shutter glasses of claim 1, wherein the synchronization image is set in front of the plurality of images.

5. A three-dimensional video system for displaying three-dimensional images, comprising:
a display;
an image display control unit, coupled to the display, for controlling the display to generate a plurality of images including a synchronization image; and
shutter glasses, comprising:
a first lens;
a second lens;
a lens control module, coupled to the first lens and the second lens, for alternately blocking the first lens and the second lens according to a synchronization signal;
an image capturing device, for capturing the synchronization image outputted from the display; and
a timing generating module, coupled to the image capturing device, for generating the synchronization signal according to the synchronization image.

6. The three-dimensional video system of claim 5, wherein the timing generating module comprises:
an oscillator, for generating a clock signal; and
a calibrating unit, coupled to the image capturing device and the oscillator, for adjusting the clock signal according to the synchronization image, making frequency and phase of the clock signal be identical to the synchronization image, to generate the synchronization signal.

7. The three-dimensional video system of claim 6, wherein the calibrating unit comprises:
a comparing unit, for comparing frequency and phase of the clock signal and the synchronization image, to generate a comparison result; and
an adjusting unit, for adjusting the clock signal according to the comparison result, making frequency and phase of the clock signal be identical to the synchronization image, to generate the synchronization signal.

8. The three-dimensional video system of claim 5, wherein the synchronization image is set in front of the plurality of images.

9. A shutter glasses control method for a three-dimensional video system, comprising:
outputting a plurality of images including a synchronization image from a display of the three-dimensional video system;
generating a synchronization signal according to the synchronization image; and
alternately blocking a first lens and a second lens of shutter glasses according to the synchronization signal.

10. The shutter glasses control method of claim 9, wherein the step of generating the synchronization signal according to the synchronization image comprises:
generating a clock signal; and
adjusting the clock signal according to the synchronization image, making frequency and phase of the clock signal be identical to the synchronization image, to generate the synchronization signal.

11. The shutter glasses control method of claim 10, wherein the step of adjusting the clock signal according to the synchronization image comprises:
comparing frequency and phase of the clock signal and the synchronization image, to generate a comparison result; and
adjusting the clock signal according to the comparison result, making frequency and phase of the clock signal be identical to the synchronization image, to generate the synchronization signal.

12. The shutter glasses control method of claim 9, wherein the synchronization image is set in front of the plurality of images.
